(19) United States
(12) Patent Application Publication
(10) Pub. No.: US 2008/0112066 A1
(43) Pub. Date: May 15, 2008

(54) CAMERA MODULE CAPABLE OF FIXING LENS HELD IN LENS BARREL AFTER THE LENS IS ADJUSTED IN OPTICAL AXIS DIRECTION

(75) Inventors: Hiroshi HARADA, Fukushima-ken (JP); Kazuhiro MIYAKAWA, Fukushima-ken (JP)

Correspondence Address: BEYER WEAVER LLP, P.O. BOX 70250, OAKLAND, CA, 94612-0250, US

(73) Assignee: ALPS ELECTRIC CO., LTD., Tokyo (JP)

(21) Appl. No.: 11/869,712

(22) Filed: Oct. 9, 2007

(30) Foreign Application Priority Data
Nov. 13, 2006 (JP) 2006-306168

(51) Int. Cl. G02B 7/02

(52) U.S. Cl. 359/819

(57) ABSTRACT

A camera module includes a lens barrel 4 for holding a lens 6 and a base 3 having a housing part 11 for housing the lens barrel 4. The lens barrel 4 comes in contact with an inner circumference surface of the housing part 11 of the base 3 on an outer circumference surface and can move in an optical axis direction of the lens 6. The housing part 11 of the base 3 has openings 14 on the circumference surface, and the outer circumference surface of the lens barrel 4 has welding parts 22 for welding with respect to rim parts of the openings 14.

### CLAIM OF PRIORITY

This application claims benefit of the Japanese Patent Application No. 2006-306168 filed on Nov. 13, 2006, which is hereby incorporated by reference.

### BACKGROUND OF THE INVENTION

1. Field of the Invention

The present invention relates to a camera module that has a lens in a housing. More particularly, the present invention relates to a camera module that can fix a lens held in a lens barrel after the lens is adjusted in an optical axis direction.

2. Description of the Related Art

Generally, in camera modules that have a lens in a housing, the housing is provided on a substrate on which an imaging element is disposed. The housing includes a base that is fixed to the substrate and a lens barrel that holds the lens and is fixed on the base. In order to form an image good in quality on the imaging element, the lens has to be placed at a position precisely adjusted in an optical axis direction with respect to the imaging element. For that purpose, the lens barrel for holding the lens can be adjusted in the optical axis direction with respect to the base, and after focus adjustment is performed, the lens barrel is fixed on the base. In the known camera modules, screw mechanisms have been employed between the lens barrel and the base. In the mechanisms, the lens barrel is moved by turning a screw with respect to the base in the optical axis direction to perform focus adjustment and after the adjustment is completed, the lens barrel is fixed to the base using adhesives. Such a camera module is discussed in Japanese Unexamined Patent Application Publication No. 2001-292365.

However, the known camera modules require forming the screw structure between the lens barrel and the base. Accordingly, shapes of molds for forming the screw structure become complex and it takes some time for the molding. This causes cost increase. Moreover, since adhesives are used to fix the components, it requires additional cost. Further, it takes some time until the adhesives solidify and during the solidification, the lens barrel may be slightly moved. This decreases process yield.

### SUMMARY OF THE INVENTION

The present invention has been made in view of the above, and an object of the present invention is to provide a camera module manufacturable without the screw structure between the base and the lens barrel of the housing and without using the adhesives for fixing the parts.

To solve the above-described problems, according to an aspect of the present invention, a camera module includes a lens barrel for holding a lens and a base having a housing part for housing the lens barrel. The lens barrel comes in contact with an inner circumference surface of the housing part of the base on an outer circumference surface and can move in an optical axis direction of the lens. The housing part of the base has openings on the circumference surface, and the outer circumference surface of the lens barrel has welding parts for welding with respect to rim parts of the openings.

Preferably, the camera module includes concave parts formed on the outer circumference surface of the lens barrel at positions in the vicinity of the openings of the housing part, and peripheral parts of the concave parts form protrusion-shaped convex parts to form the welding parts.

Preferably, the lens barrel has a flange part formed on an upper end part, and protrusion parts formed in a protruded shape on a bottom surface of the flange part, and a cam part having inclined surfaces on which the protrusion parts slide when the lens barrel is turned is formed on a top surface of the base.

Preferably, the welding parts of the lens barrel are welded to the rim part of the opening by hot welding.

According to the camera module, the housing part of the base has the openings on the circumference surface and the outer circumference surface of the lens barrel has the welding parts to be welded with respect to the rim part of the openings. Accordingly, the position-adjusted lens barrel can be fixed with respect to the base part by welding without using screw structures or adhesives. This enables to reduce the cost and improve the production efficiency.

Further, in the camera module, the concave parts may be formed on the outer circumference surface of the lens barrel at positions in the vicinity of the openings of the housing part, and the peripheral parts of the concave parts may form the protrusion-shaped convex parts to form the welding parts. Accordingly, the welding parts can be readily formed by pressure applied through jigs, and the lens barrel can be fixed on the base.

Further, in the camera module, on the bottom surface of the flange part formed on the upper end part of the flange part, the protrusion parts are formed in the protruded shape, and on the top surface of the base, the cam part having the inclined surfaces on which the protrusion parts slide when the lens barrel is turned is formed. Accordingly, it is possible to position the lens barrel using the simple structures of the bottom surface of the lens barrel and the top surface of the base. Further, the base and the lens barrel can be readily manufactured and the position adjustment of the lens barrel can be readily performed.

In the camera module, the welding parts of the lens barrel may be welded to the rim part of the opening by hot welding. Accordingly, the welding can be readily performed by applying heat, and the parts can be quickly solidified. Accordingly, the time necessary for the welding can be reduced.

### BRIEF DESCRIPTION OF THE DRAWINGS

FIG. 1 is a cross sectional view illustrating a camera module according to an embodiment of the present invention;

FIG. 2 is an exploded perspective view illustrating a top of a base and a lens barrel; and

FIGS. 3A, 3B, and 3C are cross sectional views illustrating each process in manufacturing of a camera module.

### DESCRIPTION OF THE PREFERRED EMBODIMENTS

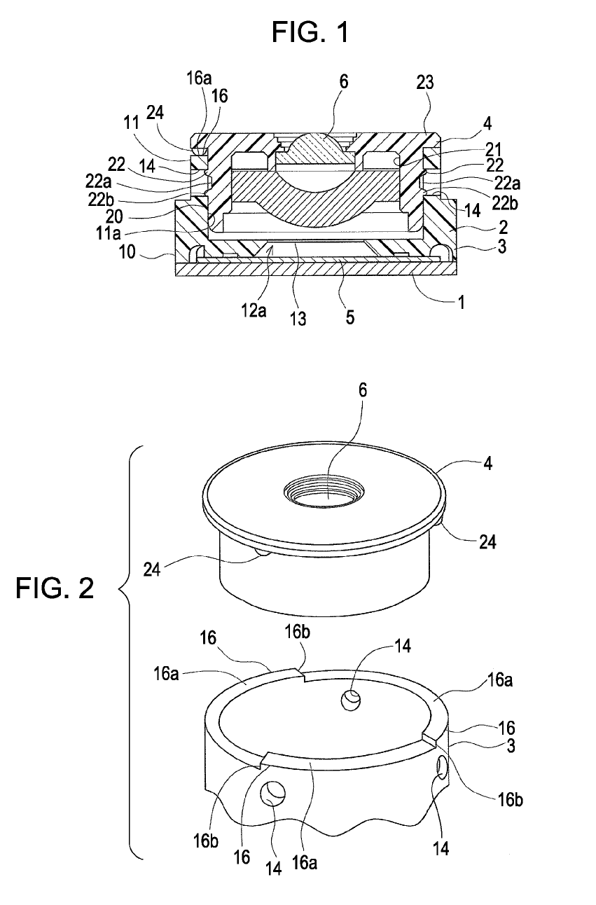

Hereinafter, an embodiment of the present invention will be described in detail with reference to the attached drawings. FIG. 1 is a cross sectional view illustrating a camera module according to an embodiment of the present invention. As shown in the drawing, in the camera module, a housing 2 is disposed on a substrate 1. An imaging element 5 is disposed on a top surface of the substrate 1, and the housing 2 includes a base 3 that is fixed on the substrate 1 and a lens barrel 4 that is fixed on the base 3 and holds a lens 6 in its inside.

The substrate 1 is formed in a plate shape and on the top surface, the imaging element 5 composed of a CMOS or a CCD is disposed. On the imaging element 5, light from a target object is taken through the lens 6 and an image is formed. The imaging element 5 converts the received light into an electrical signal, and outputs the converted signal.

The base 3 of the housing 2 is formed by shaping a resin material, and at a bottom of the base 3, a base part 10 that is a fixing part with respect to the substrate 1 is formed, and at the top of the base 3, a substantially cylindrical shaped housing part 11 that houses the lens barrel 4 is formed respectively. At an inner circumference bottom of the housing part 11, a bottom surface 12 that has an opening 12a is formed. On the top surface, a filter 13 is disposed to cover the opening 12a.

The lens barrel 4 of the housing 2 is formed by shaping a resin material similarly to the base 3, and formed in a cylindrical shape to hold the lens 6 in its inner circumference surface 21. On an upper end part of the lens barrel 4, a flange part 23 is formed over the periphery. The lens 6 condenses light from the target object, and in the embodiment, a combination of a convex lens and a concave lens is used. However, the combination of the lens 6 is not limited to the above, one lens or combinations of three or more lenses can be used.

An outer circumference surface 20 of the lens barrel 4 is formed to substantially fit into the housing part 11 of the base 3, and has a diameter to come in contact with an inner circumference surface 11a of the housing part 11. The outer circumference surface 20 of the lens barrel 4 is formed so that the outer circumference surface 20 can move to adjust in an optical axis direction of the lens 6 with respect to the inner circumference surface 11a of the housing part 11.

On a circumferential surface of the housing part 11 of the base 3, openings 14 are formed to pass through the surface in a circumferential direction. On the other hand, on the outer circumference surface 20 of the lens barrel 4, welding parts 22 are formed at positions corresponding to the openings 14. The welding part 22 has a concave part 22a that is formed in a concave shape in the vicinity of the opening 14, and a convex part 22b that rises from the peripheral part of the concave part 22a. The convex part 22b is welded to the rim of the inner circumference surface side of the opening 14 to fix the lens barrel 4 with respect to the base 3.

The lens barrel 4 can be fixed to the base 3 if at least one pair of the opening 14 of the base 3 and the welding part 22 of the lens barrel 4 is provided. However, to firmly fix the lens barrel 4 to the base 3, it is preferable to provide a plurality of pairs, for example, four pairs of opening 14 and the welding part 22 can be formed at each 90 degrees in the circumference direction. It is noted that the number of the pairs can be appropriately set.

On a bottom surface of the flange part 23 that is formed at the upper end part of the lens barrel 4, protrusion parts 24 are formed in a protruded shape in the circumference direction. On the other hand, on a top surface of the base 3 on which the flange part 23 is disposed, a cam part 16 that has an inclined plane 16a is formed. The protrusion parts 24 can slide on the cam part 16 when the lens barrel 4 is turned.

FIG. 2 is a perspective view illustrating the vicinity of the upper end of the base 3 and the lens barrel 4.

As shown in FIG. 2, on the top surface of the base 3, the cam parts 16 are formed at every 120 degrees in the circumference direction. Each inclined plane 16a is formed to incline in a same direction from the top surface of the base 3 to smoothly rise, and from a top, the plane is shaped at a substantially right angle to form a stepped part 16b.

The protrusion parts 24 can slide on the inclined planes 16a by turning the lens barrel 4 within a range shorter than the length of the inclined plane 16a in the circumference direction in a state that the protrusion parts 24 are on the inclined planes 16a of the cam part 16. In response to the movement, a position of the lens barrel 4 with respect to the base part 3 can be changed in the optical axis direction of the lens 6. That is, the movement enables to perform focus adjustment of the lens 6 with respect to the imaging element 5.

As described above, the lens barrel 4 can move with respect to the base 3 in the optical axis direction of the lens 6 by the slide of the top surface of the base 3 and the bottom surface of the flange part 23 of the lens barrel 4. Accordingly, it is not necessary to form screws or the like on the outer circumference surface of the lens barrel 4 and on the inner circumference surface of the base 3. This enables to form the base 3 and the lens barrel 4 in simple shapes, and the productivity of the molding can be improved.

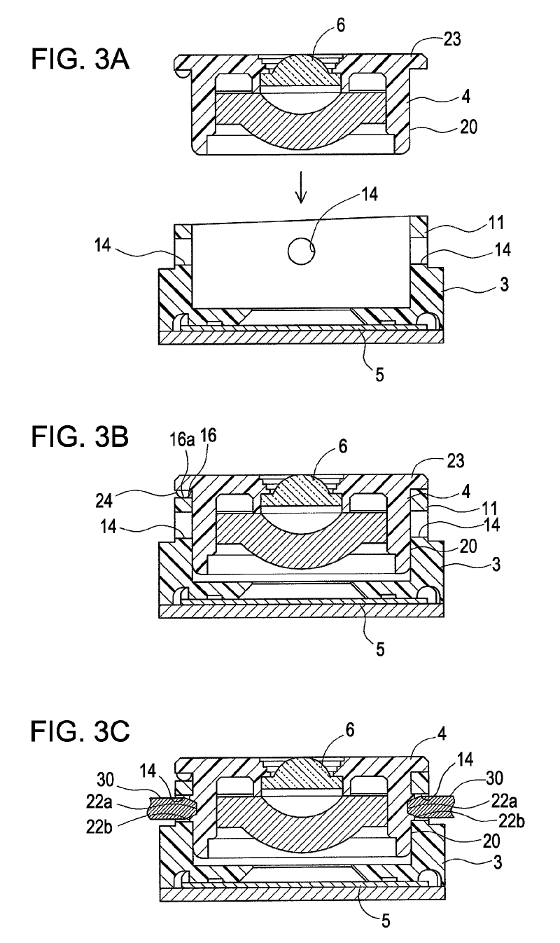

Now, manufacturing process of the camera module will be described. FIGS. 3A, 3B, and 3C are cross sectional views illustrating each process in manufacturing of the camera module. As shown in FIG. 3A, the lens barrel 4 is inserted from above into the housing part 11 of the base 3 whose upper part is formed to open. At this process, the welding parts 22 are not formed on the outer circumference surface 20 of the lens barrel 4. Accordingly, the lens barrel 4 can be smoothly inserted into the housing part 11.

When the lens barrel 4 is inserted into the housing part 11, the parts are set as shown in FIG. 3B. Then, electric power is applied to the imaging element 5, an image formed on the imaging element 5 through the lens 6 is output, and in the state, the lens barrel 4 is turned with respect to the base 3 as described above. By the operation, the protrusion parts 24 formed on the flange part 23 of the lens barrel 4 slide on the inclined planes 16a of the cam part 16 formed on the top surface of the base 3. Then, the lens barrel 4 moves with respect to the base 3 in the optical axis direction of the lens 6 to find an infocus position based on the output image, and thus, the focus adjustment is performed.

After the position of the lens barrel 4 is fixed by the focus adjustment, then, as shown in FIG. 3C, jigs 30 are inserted from the openings 14 formed on the circumference surface of the housing part 11 of the base 3. The jig 30 is formed in a bar-shape, and formed to be tapered off at a tip portion. Moreover, the jig 30 is formed to generate heat at least at the tip portion. When the jig 30 are inserted from the openings 14 and come in contact with the outer circumference surface 20 of the lens barrel 4, the jigs 30 generate heat and soften the contact parts of the lens barrel 4. Then, the jigs 30 are further slightly inserted from the position of the outer circumference surface 20 of the lens barrel 4, and the outer circumference surface 20 of the lens barrel 4 is concaved to form the concave parts 22a. Then, the peripheral parts of the concave parts 22a rise and the convex parts 22b are formed. Accordingly, the convex parts 22b come close contact with the peripheral parts of the inner circumference surface side of the openings 14.

In the state, the jigs 30 are removed, and the concave parts 22a and the convex parts 22b solidify. Then, the convex parts 22b are welded with respect to the peripheral parts of the inner circumference side of the openings 14 to form the welding parts 22 as shown in FIG. 1. According to the process, the focus-adjusted lens barrel 4 is fixed with respect to the base 3. Because it takes only several seconds from the jigs 30 are removed until the resin is solidified and welded, the time necessary for the fixation is shorter than that in the case the lens barrel 4 and the base 3 are fixed together using adhesives. Accordingly, the manufacturing efficiency can be improved and the problem that the position of the lens barrel 4 is displaced with respect to the base 3 at the fixation can be reduced.

Although the invention has been described with reference to the preferred embodiment, it is noted that equivalents may be employed and substitutions made herein without departing from the technical concepts of the invention as recited in the claims.

What is claimed is:

1. A camera module having a lens barrel for holding a lens and a base having a housing part for housing the lens barrel,
wherein the lens barrel comes in contact with an inner circumference surface of the housing part of the base on an outer circumference surface and can move in an optical axis direction of the lens, the housing part of the base has openings on the circumference surface, and the outer circumference surface of the lens barrel has welding parts for welding with respect to rim parts of the openings.

2. The camera module according to claim 1, wherein concave parts are formed on the outer circumference surface of the lens barrel at positions in the vicinity of the openings of the housing part, and peripheral parts of the concave parts form protrusion-shaped convex parts to form the welding parts.

3. The camera module according to claim 1, wherein the lens barrel has a flange part formed on an upper end part, and protrusion parts formed in a protruded shape on a bottom surface of the flange part, and a cam part having inclined surfaces on which the protrusion parts slide when the lens barrel is turned is formed on a top surface of the base.

4. The camera module according to claim 1, wherein the welding parts of the lens barrel are welded to the rim part of the opening by hot welding.
